(19) United States
(12) Patent Application Publication
(10) Pub. No.: US 2020/0204884 A1
(43) Pub. Date: Jun. 25, 2020

(54) Correlation-Based Sensor Network and Control Method thereof

(71) Applicant: Arasens, Inc., Taipei city (TW)

(72) Inventors: Michael Da-Yu Lin, Taipei City (TW); Chia-Fu Wu, Hsinchu County (TW)

(21) Appl. No.: 16/231,968

(22) Filed: Dec. 25, 2018

(51) Int. Cl. H04Q 9/00

(52) U.S. Cl. CPC H04Q 9/00; H04W 84/18

(57) ABSTRACT

A sensor network includes a first sensor, a second sensor and a controller. The first sensor is used to acquire a first type of data. The second sensor is arranged in proximity to the first sensor, and used to acquire a second type of data. The controller is coupled to the first sensor and the second sensor, and used to compute a correlation between the first type of data and the second type of data, and when the correlation exceeds a correlation threshold, control the first sensor to operate according to the second type of data.

### BACKGROUND OF THE INVENTION

1. Field of the Invention

The invention relates to sensor networks, and specifically, to a sensor network and a control method thereof.

2. Description of the Prior Art

The technological advancements in sensors, microcontrollers and communications have made deployment of a large number of sensors in sensor networks economically feasible. Because it is infeasible to recharge batteries of sensors in sensor networks, the sensors' operations are constrained by power available in the batteries, and therefore, power consumption of the sensors is a major operational concern.

Further, sensor networks are frequently employed to collect, process, transfer and analyze information in various environments. In certain rural environments such as maritime, agricultural or mining environments, Internet connections are only accessible via a satellite system or a Low Power Wide Area Network (LPWAN), and since the Internet connections as such are scarce, slow and expensive, Internet data usage becomes a main issue.

Therefore there arises a need for a sensor network capable of extending sensor battery life, conserving data usage, reducing operational costs, while sending critical sensor data to a remote data server.

### SUMMARY OF THE INVENTION

In one aspect of the invention, a sensor network including a first sensor, a second sensor and a controller is provided. The first sensor is used to acquire a first type of data. The second sensor is arranged in proximity to the first sensor, and used to acquire a second type of data. The controller is coupled to the first sensor and the second sensor, and used to compute a correlation between the first type of data and the second type of data, and when the correlation exceeds a correlation threshold, control the first sensor to operate according to the second type of data.

In another aspect of the invention, a control method adopted by a sensor network is disclosed. The control method comprises: a first sensor acquiring a first type of data; a second sensor acquiring a second type of data; a controller computing a correlation between the first type of data and the second type of data; and when the correlation exceeds a correlation threshold, the controller controlling the first sensor to operate according to the second type of data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data monitoring system according to an embodiment of the invention.

FIG. 2 is a flowchart of a control method according to an embodiment of the invention.

FIG. 3 is a flowchart of a data reduction method incorporated in Step 5210 in FIG. 2.

FIG. 4 is a flowchart of another data reduction method incorporated in Step 5210 in FIG. 2.

FIG. 5 is a flowchart of yet another data reduction method incorporated in Step 5210 in FIG. 2.

### DETAILED DESCRIPTION

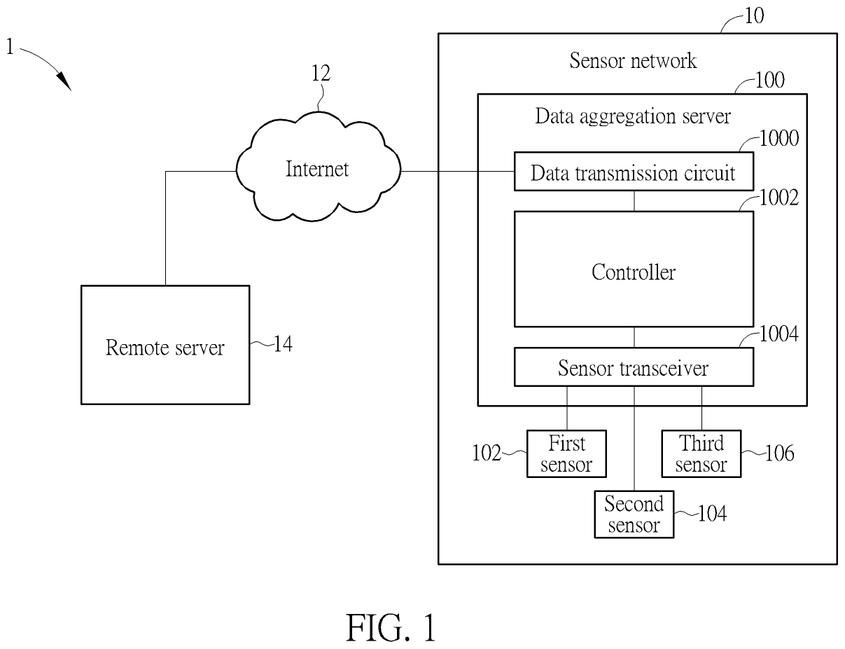

FIG. 1 is a block diagram of a data monitoring system 1 according to an embodiment of the invention. The data monitoring system 1 comprises a sensor network 10, Internet 12 and a remote server 14. The sensor network 10 may transmit sensor data in a wired manner or wireless manner via the Internet 12 to the remote server 14. The data monitoring system 1 may be used in a Low Power Wide Area Network (LPWAN) such as NarrowBand Internet of Things (NB-IoT) or Long Term Evolution (LTE) Cat-M1 where the data transfer rate and data bandwidth are limited and small data transfer is preferred.

The sensor network 10 comprises a data aggregation server 100, a first sensor 102, a second sensor 104 and a third sensor 106. The data aggregation server 100 may gather sensor data from the first sensor 102, the second sensor 104 and the third sensor 106 prior to transmitting the sensor data to the remote server 14. The data aggregation server 100 comprises a sensor transceiver 1000, a controller 1002 and a data transmission circuit 1004. The first sensor 102, the second sensor 104 and the third sensor 106 are coupled to the sensor transceiver 1000, and the sensor transceiver 1000 in turn is coupled to the controller 1002 and the data transmission circuit 1004. The first sensor 102, the second sensor 104 and the third sensor 106 may be arranged in the proximity to each other.

The first sensor 102, the second sensor 104 and the third sensor 106 may be different types of sensors acquiring different types of data from the environment. Specifically, the first sensor 102 may acquire a first type of data, the second sensor 104 may acquire a second type of data, and the third sensor 106 may acquire a third type of data. For example, the first sensor 102 may be a speed sensor acquiring rotational speed data of an engine on a boat, the second sensor 104 may be a global positioning system (GPS) sensor acquiring GPS location data of the boat, and the third sensor 106 may be a pressure sensor acquiring pressure data of a fuel tank on the boat. The first sensor 102, the second sensor 104 and the third sensor 106 may respectively transmit the first type of data, the second type of data and the third type of data to the controller 1002 via the sensor transceiver 1000, and respectively receive a first sensor operation parameter, a second sensor operation parameter and a third sensor operation parameter from the controller 1002 via the sensor transceiver 1000. The first sensor operation parameter, the second sensor operation parameter and the third sensor operation parameter serve to set settings in the first sensor 102, the second sensor 104 and the third sensor 106, respectively. It should be noted that in various embodiments of the invention, any plural number of sensors may be incorporated in the sensor network 10 to produce plural types of data.

For simplicity in explanation, a case concerning only the first sensor 102 and the second sensor 104 is addressed to illustrate operations of the controller 1002. However, it should be understood that the same operations of the controller 1002 can be applied to any two of the first sensor 102, the second sensor 104 and the third sensor 106. The controller 1002 may compute a correlation between the first type of data and the second type of data, and when the correlation exceeds a correlation threshold, control the first sensor 102 to operate according to the second type of data. The correlation may be a coefficient of determination or a Pearson correlation coefficient. The controller 1002 may determine whether the first type of data and the second type of data are correlated according to the correlation, a regression analysis, or a correlation ranking process. When the correlation between the first type of data and the second type of data exceeds the correlation threshold, the controller 1002 may determine that the first type of data and the second type of data are correlated, and as a result, the controller 1002 may control operations of the first sensor 102 according to the second type of data. For example, the controller 1002 may reduce a frequency of performing the operations or turn off the operations of the first sensor 102 when the second type of data shows little or no change over time. When the correlation is less than or equal to the correlation threshold, the controller 1002 may determine that the first type of data and the second type of data are uncorrelated, and the controller 1002 may not control operations of the first sensor 102 according to the second type of data and may leave the settings of the first sensor 102 and the second sensor 104 unchanged.

In one embodiment, when the correlation exceeds the correlation threshold, the controller 1002 may set, according to the second type of data, a first transmission frequency at which the first sensor 102 transmits the first type of data to the controller 1002. For example, a speed sensor may acquire rotational speed data of an engine on a boat and a GPS sensor may acquire GPS location data of the boat, the controller 1002 may determine that the rotational speed data of the engine and the GPS location data are correlated when the correlation between the rotational speed data of the engine and the GPS location data exceeds a correlation threshold, and when the rotational speed data and the GPS location data are correlated and the GPS location data remains substantially constant over time, the controller 1002 may dynamically set a transmission frequency of the speed sensor by decreasing the transmission frequency. Consequently, the speed sensor may transmit the rotational speed data of the engine to the controller 1002 at the decreased transmission frequency, thereby conserving power of the speed sensor while not losing or losing very little information of the rotational speed data.

In another embodiment, when the correlation exceeds the correlation threshold, the controller 1002 may set, according to the second type of data, a first sampling frequency at which the first sensor 102 acquires the first type of data. For example, a speed sensor may acquire rotational speed data of an engine on a boat and a GPS sensor may acquire GPS location data of the boat, when a correlation between the rotational speed data and the GPS location data exceeds the correlation threshold and the GPS location data remains substantially constant over time, the controller 1002 may dynamically set a sampling frequency of the speed sensor by decreasing the sampling frequency. Consequently, the speed sensor may acquire the rotational speed data of the engine at the decreased sampling frequency, thereby conserving power of the speed sensor while not losing or losing very little information of the rotational speed data.

In still another embodiment, when the correlation exceeds the correlation threshold, the controller 1002 may dynamically set, according to the second type of data, a first transmission duration in which the first sensor 102 transmits the first type of data to the controller 1002. When the first type of data and the second type of data are correlated and the second type of data remains substantially constant over time, the controller 1002 may set the first transmission duration by decreasing the first transmission duration. As a result, the first sensor 102 may only transmit the first type of data to the controller 1002 during the decreased transmission duration, thereby reducing power consumption of the first sensor 102 while not losing or losing very little information of the first type of data.

In yet another embodiment, when the correlation exceeds the correlation threshold, the controller 1002 may dynamically set, according to the second type of data, a first sampling duration in which the first sensor 102 acquires the first type of data. When the first type of data and the second type of data are correlated and the second type of data remains substantially constant over time, the controller 1002 may set the first sampling duration by decreasing the first sampling duration. As a result, the first sensor 102 may only acquire the first type of data to the controller 1002 during the decreased sampling duration, thereby reducing power consumption of the first sensor 102 while not losing or losing very little information of the first type of data.

In still yet another embodiment where a coefficient ranking process is adopted, the controller 1002 may compute correlations of two or more pairs of sensors among the first sensor 102, the second sensor 104 and the third sensor 106, rank the correlations in descending order, determine a potentially correlated sensor pair having a correlation exceeding a rank threshold, and for the potentially correlated sensor pair, control one sensor in the potentially correlated sensor pair to operate according to data acquired by the other sensor in the potentially correlated sensor pair. Similarly, the controller 1002 may also rank the correlations in ascending order, determine a potentially correlated sensor pair having a correlation less than another rank threshold, and for the potentially correlated sensor pair, control one sensor in the potentially correlated sensor pair to operate according to data acquired by the other sensor in the potentially correlated sensor pair.

The controller 1002 may further include all the first type of data, the second type of data and the third type of data in one data package, and transmit the data package to the data transmission circuit 1004. Accordingly, the data transmission circuit 1004 may transmit the reduced data in the data package to the remote server 14 via the Internet 12 at regular intervals and in real time. In particular, the controller 1002 may reduce data sizes of the first type of data, the second type of data and the third type of data to generate reduced data before including the reduced data in the data package. The controller 1002 may reduce the data sizes by performing data mapping, data encoding, data compression, or other data reduction processes on the first type of data, the second type of data and the third type to generate the reduced data, include in the data package a flag indicating the data reduction process performed on the first type of data, the second type of data or the third type of data, and transmit the data package to the remote server 12 via the data transmission circuit 1004. Upon receiving the data package, the remote server 12 may recover the first type of data, the second type of data or the third type of data according to the flag and the reduced data. As a result, the data aggregation server 100 can conserve data bandwidth of the uplink connection, while not losing or losing very little information of the rotational speed data and GPS location data.

In one embodiment, for the case addressing the first sensor 102 and the second sensor 104, the controller 1002 may remove redundant data from the first type of data and the second type of data according to the correlation to generate reduced data, and the data transmission circuit 1004 may transmit the reduced data via the Internet 12 to the remote server 14. For example, when the first type of data and the second type of data are correlated by a linear relationship or a perfect positive correlation relationship, the controller 1002 may remove one of the first type of data and the second type of data to generate reduced data, and the data transmission circuit 1004 may transmit the reduced data and a scaling factor between the first type of data and the second type of data to the remote server 14. Later, the remote server 14 may recover the removed first type of data or second type of data according to the reduced data and the scaling factor.

In another embodiment, the controller 1002 may compute a first difference between adjacent data in the first type of data and a second difference between adjacent data in the second type of data, and the data transmission circuit 1004 may transmit the first difference and the second difference to the remote server 14. When data sizes of the first difference and the second difference are less than a predefined data size, the data transmission circuit 1004 may transmit the first difference and the second difference in place of the first type of data and the second type of data having full data sizes, thereby reducing the required data bandwidth. For example, one GPS coordinate typically takes up 4 to 8 bytes of the data space in a GPS message, but a difference between consecutive GPS coordinates can be much less than 4 to 8 bytes. When the difference is less than the predefined data size, the controller 1002 may set a flag in the GPS message indicating that a difference of the GPS coordinates is being transmitted, and the data transmission circuit 1004 may transmit the flag along with the difference to the remote server 14.

When the correlation between the first sensor 102 and the second sensor 104 exceeds the correlation threshold and the second type of data remains substantially constant over a time interval, the data transmission circuit 1004 may further stop transmission of the first type of data and the second type of data in the time interval. In particular, the second type of data remains substantially constant when a change in adjacent data in the second type of data is less than a data change threshold.

The data monitoring system 1 may be adopted by an LPWAN, and can reduce data redundancy, conserve power, reduce data usage and decrease operational costs while providing the real-time sensor data to the remote server 14 without losing or losing only little information. Furthermore, the sensor network 10 may be adopted in a satellite communications system where data connection is costly and data bandwidth is limited. The sensor data is transmitted from the data aggregation server 100 via a satellite to the remote server 14 over radio signals. For the satellite communications system, the sensor network 10 can likewise be used to reduce data redundancy, conserve power, reduce required data bandwidth and reduce operation costs while providing the real-time sensor data without losing or losing only little information. The configurations and operations of the sensor network 10 remain unchanged as those disclosed in the preceding paragraphs, and explanation therefor is omitted for brevity.

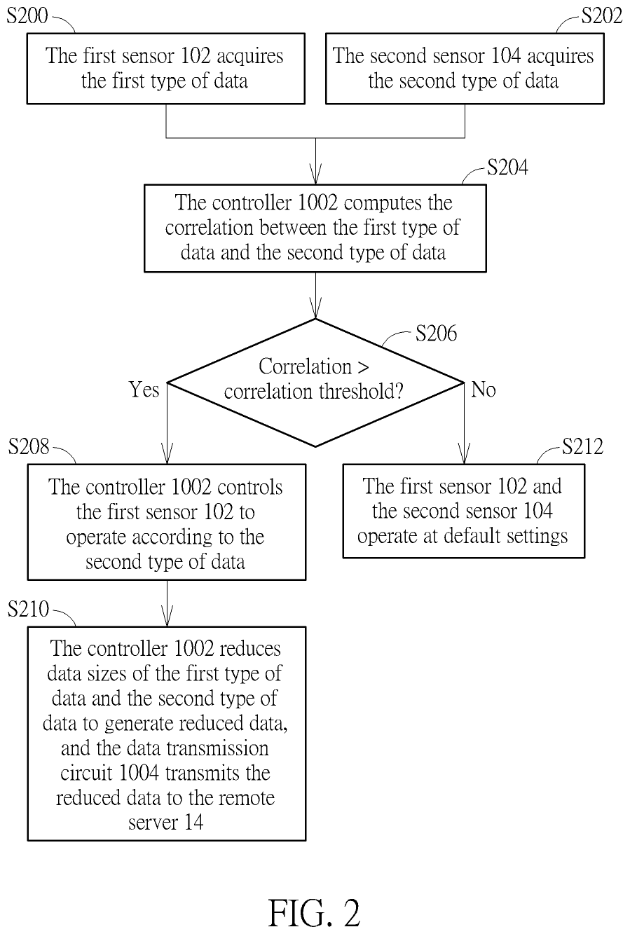

Examples of interactions between the components in the sensor network 10 in FIG. 1 are now described with respect to a control method shown in FIG. 2. The control method in FIG. 2 describes the control of the first sensor 102, the second sensor 104 and the data transmission circuit 1004, and comprises steps S200 through S212. Any reasonable technological change or Step adjustment is within the scope of the present application. The steps S200 through S212 are detailed as below:
S200: The first sensor 102 acquires the first type of data;
S202: The second sensor 104 acquires the second type of data;
S204: The controller 1002 computes the correlation between the first type of data and the second type of data;
S206: Correlation>correlation threshold? If so, go to Step S208; else go to Step S212;
S208: The controller 1002 controls the first sensor 102 to operate according to the second type of data;
S210: The controller 1002 reduces data sizes of the first type of data and the second type of data to generate reduced data, and the data transmission circuit 1004 transmits the reduced data to the remote server 14.
S212: The first sensor 102 and the second sensor 104 operate at default settings.

In the step S200, the first sensor 102 acquires the first type of data, and in the step S202, the second sensor 104 acquires the second type of data. The step S200 and the step 202 may be performed in parallel and at the same frequency to acquire two time series containing data sampled at substantially the same points in time.

In the step S204, the controller 1002 computes the correlation between the first type of data and the second type of data. The correlation may be a coefficient of determination or a Pearson correlation coefficient. The correlation represents dependence or a predictable relationship between the first type of data and the second type of data, and may represent, but is not limited to, whether the first type of data and the second type of data have a linear relationship with each other.

In the step S206, the controller 1002 determines whether the correlation exceeds the correlation threshold. If so, the controller 1002 may determine that the first type of data and the second type of data are correlated; and if not, the controller 1002 may determine that the first type of data and the second type of data are uncorrelated.

In the step S208, when the correlation exceeds the correlation threshold, the controller 1002 controls the first sensor 102 to operate according to the second type of data. Specifically, the controller 1002 may set operation parameters of the first sensor 102 and the second sensor 104 in order to conserve power upon identifying a correlation. The operation parameters include a transmission frequency, a sampling frequency, a transmission duration, a sampling duration, a transmission pattern and other operation parameters. The transmission frequency is a frequency at which the first sensor 102 or the second sensor 104 may transmit the corresponding first type of data or second type of data to the controller 1002 via the sensor transceiver 1000. The sampling frequency is a frequency at which the first sensor 102 or the second sensor 104 may acquire the corresponding first type of data or second type of data from the environment. The transmission duration is a time duration in which the first sensor 102 or the second sensor 104 may transmit the corresponding first type of data or second type of data to the controller 1002 via the sensor transceiver 1000. The sampling duration is a time duration in which the first sensor 102 or the second sensor 104 may acquire the corresponding first type of data or second type of data from the environment. The transmission pattern is a timing pattern specifying when the first sensor 102 or the second sensor 104 may transmit the corresponding first type of data or second type of data to the controller 1002, receive the corresponding first sensor operation parameter or second sensor operation parameter, or remain idle without performing any operation.

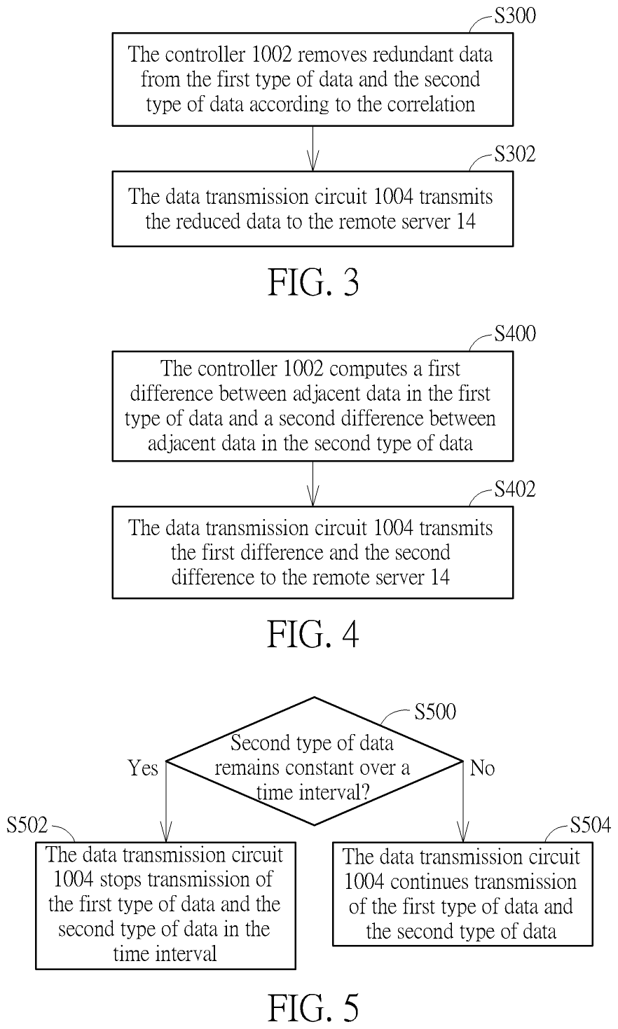

In Step S210, the controller 1002 reduces the data sizes of the first type of data and the second type of data to generate reduced data, and the data transmission circuit 1004 transmits the reduced data to the remote server 14. The controller 1002 may reduce the data sizes using data reduction methods in FIGS. 3, 4 and 5. The data transmission circuit 1004 may transmit the reduced data 14 at regular intervals, thereby reducing data bandwidth required for uploading the first type of data and the second type of data to the remote server 14.

In Step S212, when the correlation is less than or equal to the correlation threshold, the first sensor 102 and the second sensor 104 operate at default settings. Since the first type of data and the second type of data are uncorrelated, data redundancy is not present in the first type of data or the second type of data, and the first sensor 102 and the second sensor 104 must acquire full sets of first type of data and the second type of data in order not to lose any critical information.

FIG. 3 is a flowchart of a data reduction method incorporated in Step S210 in FIG. 2. The data reduction method in FIG. 3 is used to reduce data sizes of data to be transmitted to the remote server 14, and comprises Steps S300 and S302 as below:
S300: The controller 1002 removes redundant data from the first type of data and the second type of data according to the correlation;
S302: The data transmission circuit 1004 transmits the reduced data to the remote server 14.

Details of Steps S300 and S302 are provided in the preceding paragraphs, and explanation therefor is omitted for brevity.

FIG. 4 is a flowchart of another data reduction method incorporated in Step S210 in FIG. 2. The data reduction method in FIG. 4 is used to reduce data sizes of data to be transmitted to the remote server 14, and comprises Steps S400 and S402 as below:
S400: The controller 1002 computes a first difference between adjacent data in the first type of data and a second difference between adjacent data in the second type of data;
S402: The data transmission circuit 1004 transmits the first difference and the second difference to the remote server 14.

Details of Steps S400 and S402 are provided in the preceding paragraphs, and explanation therefor is omitted for brevity.

FIG. 5 is a flowchart of yet another data reduction method incorporated in Step S210 in FIG. 2. The data reduction method in FIG. 5 is used to eliminate data not required to be transmitted, and comprises Steps S500 through S504 as below:
S500: Second type of data remains constant over a time interval? If so, go to Step S502; else go to Step S504;
S502: The data transmission circuit 1004 stops transmission of the first type of data and the second type of data in the time interval.
S504: The data transmission circuit 1004 continues transmission of the first type of data and the second type of data.

In Step S500, the controller 1002 determines whether the second type of data remains constant over a time interval. The controller 1002 may determine that the second type of data remains substantially constant when a change in adjacent data in the second type of data is less than the data change threshold. Since the first type of data and the second type of data are correlated, the constant data values of the second type of data may suggest that the first type of data also remains constant over the time interval.

In Step S502, since the first type of data likely stays constant over the time interval, the data transmission circuit 1004 stops transmission of the first type of data and the second type of data in the time interval.

In Step S504, the data transmission circuit 1004 continues transmission of the first type of data and the second type of data, since the change in the second type of data over time suggests an occurrence of a change in the first type of data in the same time interval. The data transmission circuit 1004 may transmit full sets of first type of data and the second type of data in order not to lose any critical information.

The control method and the data reduction methods in FIG. 2 through 5 can be adopted by the data monitoring system 1 to reduce data redundancy, conserve power, reduce data usage and decrease operational costs while providing the real-time sensor data to the remote server 14 without losing or losing only little information.

While embodiments of the invention have been described in terms of the data monitoring systems and control methods for marine applications, it should be appreciated that the invention can be adopted in any sensor network application where network power is insufficient and data bandwidth is limited.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensor network comprising:
a first sensor, configured to acquire a first type of data;
a second sensor, arranged in proximity to the first sensor, and configured to acquire a second type of data; and
a controller, coupled to the first sensor and the second sensor, and configured to compute a correlation between the first type of data and the second type of data, and when the correlation exceeds a correlation threshold, control the first sensor to operate according to the second type of data.

2. The sensor network of claim 1, wherein when the correlation exceeds the correlation threshold, the controller is configured to set, according to the second type of data, a first transmission frequency at which the first sensor transmits the first type of data to the controller.

3. The sensor network of claim 1, wherein when the correlation exceeds the correlation threshold, the controller is configured to set, according to the second type of data, a first sampling frequency at which the first sensor acquires the first type of data.

4. The sensor network of claim 1, further comprising a third sensor, arranged in proximity to the first sensor and the second sensor, and configured to acquire a third type of data;
wherein the controller is further coupled to the third sensor and configured to compute a correlation between the first type of data and the third type of data, rank the correlation between the first type of data and the second type of data and the correlation between the first type of data and the third type of data, determine a correlated sensor pair corresponding to a correlation in the ranked correlations and exceeding a rank threshold, and when a correlated sensor pair is determined, control one sensor of the correlated sensor pair to operate according to a corresponding type of data of the other sensor of the correlated sensor pair.

5. The sensor network of claim 1, further comprising a data transmission circuit, coupled to the controller, and configured to transmit the first type of data and the second type of data to a remote server.

6. The sensor network of claim 5, wherein when the correlation exceeds the correlation threshold and the second type of data remains substantially constant over a time interval, the data transmission circuit is further configured to stop transmission of the first type of data and the second type of data in the time interval.

7. The sensor network of claim 6, wherein the second type of data remains substantially constant when a change in adjacent data in the second type of data is less than a data change threshold.

8. The sensor network of claim 1, wherein:
the controller is further configured to remove redundant data from the first type of data and the second type of data according to the correlation to generate reduced data; and
the sensor network further comprises a data transmission circuit coupled to the controller, and configured to transmit the reduced data.

9. The sensor network of claim 1, wherein:
the controller is further configured to compute a first difference between adjacent data in the first type of data and second difference between adjacent data in the second type of data; and
the sensor network further comprises a data transmission circuit coupled to the controller, and configured to transmit the first difference and the second difference to the remote server.

10. The sensor network of claim 1, wherein the correlation is a coefficient of determination.

11. A control method, adopted by a sensor network, comprising:
a first sensor acquiring a first type of data;
a second sensor acquiring a second type of data;
a controller computing a correlation between the first type of data and the second type of data; and
when the correlation exceeds a correlation threshold, the controller controlling the first sensor to operate according to the second type of data.

12. The control method of claim 11, wherein when the correlation exceeds a correlation threshold, the controller controlling the first sensor to operate according to the second type of data comprises:
when the correlation exceeds the correlation threshold, the controller setting, according to the second type of data, a first transmission frequency at which the first sensor transmits the first type of data to the controller.

13. The control method of claim 11, wherein when the correlation exceeds a correlation threshold, the controller controlling the first sensor to operate according to the second type of data comprises:
when the correlation exceeds the correlation threshold, the controller setting, according to the second type of data, a first sampling frequency at which the first sensor acquires the first type of data.

14. The control method of claim 11, further comprising:
a third sensor acquiring a third type of data;
the controller computing a correlation between the first type of data and the third type of data;
the controller ranking the correlation between the first type of data and the second type of data and the correlation between the first type of data and the third type of data;
the controller determining a correlated sensor pair by comparing the ranked correlations to a rank threshold; and
when a correlated sensor pair is determined, the controller controlling one sensor of the correlated sensor pair to operate according to a corresponding type of data of the other sensor of the correlated sensor pair.

15. The control method of claim 11, further comprising a data transmission circuit transmitting the first type of data and the second type of data to a remote server.

16. The control method of claim 15, further comprising when the correlation exceeds the correlation threshold and the second type of data remains substantially constant over a time interval, the data transmission circuit stopping transmission of the first type of data and the second type of data in the time interval.

17. The control method of claim 16, wherein when the correlation exceeds the correlation threshold and a change in adjacent data in the second type of data is less than a data change threshold, the data transmission circuit stopping transmission of the first type of data and the second type of data.

18. The control method of claim 11, further comprising:
the controller removing redundant data from the first type of data and the second type of data according to the correlation to generate reduced data; and
a data transmission circuit transmitting the reduced data.

19. The control method of claim 11, wherein:
the controller computing a first difference between adjacent data in the first type of data and a second difference between adjacent data in the second type of data; and
a data transmission circuit transmitting the first difference and the second difference to the remote server.

20. The control method of claim 11, wherein the correlation is a coefficient of determination.
